(19) United States
(12) Patent Application Publication
(10) Pub. No.: US 2004/0046711 A1
(43) Pub. Date: Mar. 11, 2004

(54) User-controlled linkage of information within an augmented reality system

(75) Inventor: Gunthard Triebfuerst, Nuernberg (DE)

Correspondence Address: SUGHRUE MION, PLLC, 2100 PENNSYLVANIA AVENUE, N.W., WASHINGTON, DC, 20037, US

(73) Assignee: SIEMENS AG

(21) Appl. No.: 10/463,695

(22) Filed: Jun. 18, 2003

Related U.S. Application Data
(63) Continuation of application No. PCT/DE01/04543, filed on Dec. 4, 2001.

(30) Foreign Application Priority Data
Dec. 18, 2000 (DE) 100 63 089.8

(51) Int. Cl. G09G 5/00

(52) U.S. Cl. 345/8

(57) ABSTRACT

A system and a method for use, in particular, in an augmented reality environment, which improve the representation of information in terms of its user friendliness. The system includes a display unit (2) displaying information (3), an image detection unit (7) detecting objects (9) in a field of vision (8) of a user (1), a command detection unit (10) detecting the commands (4) given by the user (1), and a control unit (11) that controls the display unit (2), recognizes the objects (9) detected by the image detection unit (7) and processes the commands (4) of the user (1) detected by the command detection unit (10). The system additionally establishes a linkage between the displayed information (3) and the contemporaneously detected objects (9), wherein the linkage is controlled by the commands (4) given by the user (1).

This is a Continuation of International Application PCT/DE01/04543, with an international filing date of Dec. 4, 2001, which was published under PCT Article 21(2) in German, and the disclosure of which is incorporated into this application by reference.

### FIELD OF AND BACKGROUND OF THE INVENTION

The invention relates to a system and a method for the user-controlled linkage of information within an augmented reality system and a computer program product for implementing the method.

Such a system and method are used, for example, in automation technology, production machinery and machine tools, diagnostic/service support systems and in complex components, devices and systems, e.g., vehicles and industrial machinery and plants.

The publication WO 00/52541, which is incorporated herein by reference, discloses a system and method for situation-related interaction support between a user and a technical device with the aid of augmented reality technologies. A concrete work situation is automatically detected and analyzed, and information relevant to the analyzed work situation is automatically selected from static information and displayed. Other representative references in this field of endeavor include U.S. Pat. No. 5,579,026, issued to Tabata, and U.S. application No. 249,597, filed Feb. 12, 1999, by Dove et al., both of which are also incorporated into this application by reference.

### OBJECTS OF THE INVENTION

One object of the invention is to improve the representation of information within an augmented reality system in terms of its user friendliness.

### SUMMARY OF THE INVENTION

This and other objects, according to one formulation of the invention, are attained by a system including

a display unit displaying information,

an image detection unit detecting objects in a field of vision of a user,

a command detection unit detecting commands given by a user, and

a control unit controlling the display unit, recognizing the objects detected by the image detection unit and processing the commands of the user detected by the command detection unit,

with a linkage being provided between the displayed information and the detected objects, which are controlled by the commands given by the user.

According to another formulation, the invention encompasses a method for

displaying information,

detecting objects in a field of vision of a user,

detecting commands given by the user,

recognizing the objects detected by an image detection unit and

processing the commands of the user detected by a command detection unit,

with a linkage being provided between the displayed information and the detected objects, which can be controlled by the commands given by the user.

The system and method according to the invention are preferably used in an augmented reality environment. Objects in the field of vision of the user are detected and recognized by the system. As a function of the detected object, specific information linked to this object is superimposed on a display unit. In conventional systems of this type, the user has no ability to directly influence the content and the manner of representing this displayed information. According to the invention, the user is provided with this ability. Using commands, the user can control the linkage between the displayed information and the contemporaneously detected objects. Instead of being a passive recipient of information, the user actively intervenes in the process of providing information.

The invention is based, in part, on the finding that the information displayed in a conventional augmented reality system is “unstable.” When the image detection unit, which is typically a head-mounted unit, no longer detects the object with which the information is associated because of a head movement, this information is no longer displayed. The user must then attempt to retrieve the underlying information to be redisplayed by trying different head positions. This can be time consuming and frustrating. Once the image detection unit has redetected the object, the user must try to keep his head still, i.e., maintain his position, long enough until he has read the displayed information.

The conventional augmented reality system forces the user to assume a relatively unnatural behavior—which violates basic ergonomic principles and may result in the overall system being rejected. In contrast, the invention provides a control unit for reversibly severing the linkage between the displayed information and the contemporaneously detected objects and a display unit for displaying the information independently of the contemporaneously detected objects. This linkage, in particular, is controlled by the commands of the user. This makes it possible to “freeze” the information displayed on the display unit in accordance with the commands given by the user and to keep the information displayed in an object-independent manner until the user gives a new command to “unfreeze” the display. Overall, from the standpoint of the user, this provides the following advantages: The virtual information is initially object-dependent, i.e., it is associated with the detected object and thus gives the user an indication as to which real objects are associated with the information. However, the superimposition in the field of vision of the user, without use of the invention, is unstable and prone to faults because it depends on the constant linkage between the camera and the marked object. To stabilize the superimposed information, according to the invention, the user can “freeze” the displayed information with a corresponding command in order to be able to take the necessary time to view the object-dependent information in an object-independent manner without risking that a careless movement might break the contact. Using a further command, the user cancels this stabilization again.

According to the invention, the commands given by the user and detected by the system can be of various types. The user can control the linkage by pushing a button or using a gesture, mimicry or even just eye movements. However, a system in which the command detection unit can detect a user's voice commands is particularly advantageous. Voice interaction is advantageous because it allows the user to respond faster. If the user had to trigger the function by pushing a button, the very movements required to do so could interrupt the link between the image detection unit and the object.

To achieve communication in both directions, it is proposed that the control unit generates feedback to the user and that feedback devices are provided for transmitting this feedback to the user. It is particularly advantageous if the feedback is acoustic feedback.

According to one advantageous embodiment of the system, enabling the system to recognize the detected objects, the objects to be recognized are provided with at least one marker whose structure, which is detected by the image detection unit, is recognized by the control unit, and the detected and recognized marker is associated with information. Other conventional tracking procedures could also be used. For example, the image detection unit could recognize the structure or parts of the structure of the detected object, and virtual object-dependent information stored for this object can be displayed. The information retrieved in this manner is referred to as tracked information.

To enable the user readily to associate the displayed information with the detected object and to use the advantages afforded by augmented reality technology, it is proposed that a head-mounted display (e.g., data goggles) be used as the display unit and that the information be superimposed on the field of vision of the user.

The proposed system can be readily adapted to be used in an augmented reality environment for the object-independent representation on the display unit of information that was previously retrieved in an object-dependent manner. This object-independent representation can be started and terminated by the commands of the user.

### BRIEF DESCRIPTION OF THE DRAWINGS

The invention will now be described and explained in greater detail, by way of example, with reference to an embodiment depicted in the figures in which:

FIG. 1 is an exemplary embodiment of a system in an augmented reality environment,

FIG. 2 shows the field of vision of a user in an object-dependent representation of the information,

FIG. 3 shows the field of vision of the user in a object-independent representation of the information, and

FIG. 4 is a schematic representation of the interactive command process.

### DETAILED DESCRIPTION OF THE PREFERRED EMBODIMENTS

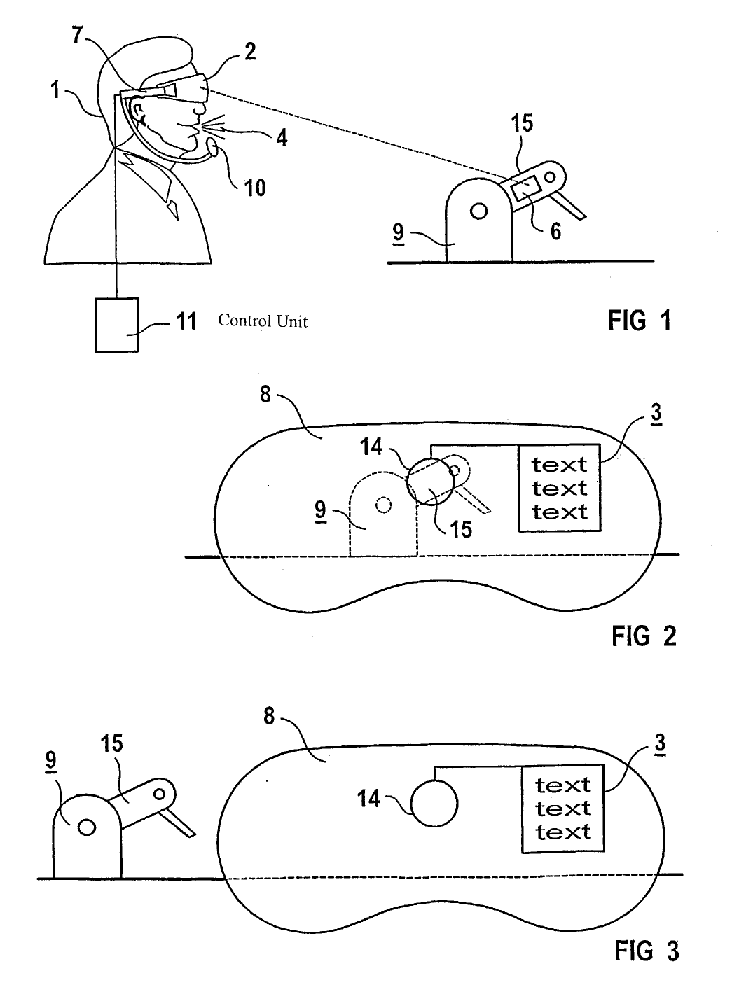

FIG. 1 shows an exemplary embodiment of a system in an augmented reality environment in which a user 1 wears a head-mounted display 2 and gives commands 4 to a control unit 11 through a headset microphone 10. A video camera 7 attached to the head-mounted display 2 of the user detects an object 9, e.g., a machine tool with a component 15, in the field of vision of the user 1. The machine tool 9 and its component 15 are identified by a marker 6.

In the scenario depicted in FIG. 1, a service technician 1 is supposed to repair a defective component 15 of the machine tool 9. The service technician carries a control unit 11 in the form of a mobile computer on his body and wears a head-mounted display 2. The service technician 1 looks at the component 15, which is identified by the marker 6 and backed by augmented reality information 3. The camera 7 on the head-mounted display 2 detects the marker 6 and superimposes the corresponding virtual information 3 on the display 2 and thereby on the field of vision 8 of the technician 1. The technician 1 can give commands 4 to the control unit 11 through a headset microphone 10.

FIG. 2 shows the field of vision 8 of the technician 1 in an object-dependent representation of the information 3 and the observed object 9 with a component 15. In the case of the object-dependent representation shown, the augmented information 3 is displayed in the field of vision 8 of the technician 1 in such a way (e.g., identified by a colored circle 14 drawn around a component 15 of the machine tool 9) that the technician 1 can clearly associate the information 3 with this component 15. The augmented information 3 in the specific embodiment shown includes textual instructions as to which tool is required and how this component 15 can be dismantled. The technician 1 sees the component 15 identified by the circle 14 in his central field of vision and registers the textual instructions in his peripheral field of vision. In the object-dependent mode, if the technician 1 moves his head away from the object, the information 3 on the display 2, being linked to the component 15 of the machine tool 9, is canceled. Thus, the displayed information 3 is removed from the display 2 and consequently from the field of vision 8 of the technician 1.

In contrast thereto, FIG. 3 shows the field of vision 8 of the technician 1 in an object-independent representation of the information 3. In this case, the augmented information 3 superimposed on the display 2, i.e. on the field of vision 8 of the technician 1, remains fixed, even if the technician moves his head and the machine tool 9 is therefore no longer in the technician's field of vision 8.

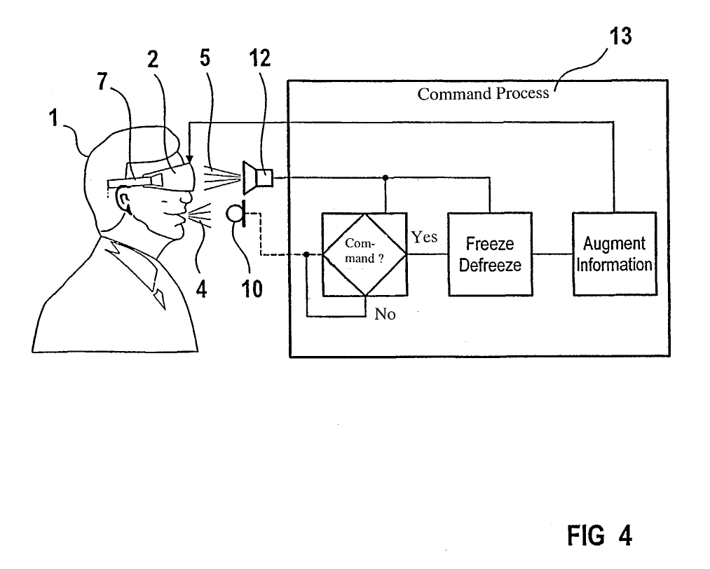

FIG. 4 schematically illustrates an interactive command process 13 implemented in the control unit 11 using the acoustic variant by way of example. The command process per se is illustrated in the block diagram 13. In addition, the figure shows the technician 1 wearing a head-mounted display 2 with a camera 7, a microphone 10 and a loudspeaker 12. The voice commands of the technician 1 are identified by the reference numeral 4 and the acoustic feedback of the control unit 11 by the reference numeral 5.

The technician 1 gives a voice command 4 to the control unit 11 through the microphone 10 in order to be able to take his time to read the text information 3 shown in his field of vision 8 even if he moves his head. The command process 13 is then executed in the control unit 11. If the command is not recognized, a corresponding acoustic feedback 5 is provided to the technician 1 through a loudspeaker or a headset 12. If, on the other hand, the command 4 is recognized, an acoustic feedback is likewise provided. In the example shown, the technician 1 activates the interruption of the linkage between the displayed information 3 and the object 9 by giving the voice command, e.g. “freeze.” In this case, the control unit 11 freezes, or stabilizes, the information 3 on the display 2. Now the technician 1 can move his head freely without the information 3 disappearing from his field of vision 8. For example, he begins to read the information 3: first he has to get a specific wrench out of his toolbox. While he goes to the toolbox, he continues to read the displayed information 3 to find out the next step. Now that he knows the steps involved in the disassembly, he no longer needs the augmented but “frozen” information. With another voice command 4, e.g., “defreeze,” he triggers the command process 13 again. This command 4 causes the control unit 11 to reverse the “freeze”, i.e., to make the displayed information 3 object-dependent again. If the object 9 with which the information 3 is associated is no longer in the field of vision 8 of the technician 1, this information 3 is cleared from the display 2, as described above.

The advantage provided by augmented reality technology, which is that the virtual information 3 is directly linked with the associated real object 9 and can therefore be associated exactly with that object, is thus combined with the advantages offered the user 1 by an object-independent information display. With the aid of a freeze function, tracked and originally object-dependent augmented information 3 can become object-independent as required, so that this previously “unstable” information 3 is now stable. For reasons of response speed, this function is advantageously and preferably activated and deactivated through voice input.

In summary, the invention thus relates to a system and a method in an augmented reality environment, which improves the representation of information in terms of its user friendliness. The system, in its preferred embodiment, includes a display unit 2 for displaying information 3, an image detection unit 7 for detecting objects 9 in a field of vision 8 of a user 1, a command detection unit 10 for detecting commands 4 given by the user 1 and a control unit 11 for controlling the display unit 2, recognizing the objects 9 detected by the image detection unit 7 and processing the commands 4 of the user 1 detected by the command detection unit 10. A linkage is provided between the displayed information 3 and the contemporaneously detected objects 9, which can be controlled by the commands 4 given by the user 1.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. System comprising:
a display unit displaying information,
an image detection unit detecting objects in a field of vision of a user,
a command detection unit detecting commands given by the user, and
a control unit controlling the display unit, recognizing the objects detected by the image detection unit, and processing the commands of the user detected by the command detection unit,
wherein the control unit further provides a linkage, controlled by the commands given by the user, between the displayed information and the contemporaneously detected objects.

2. The system as claimed in claim 1, wherein:
the control unit reversibly interrupts the linkage between the display information and the contemporaneously detected objects in accordance with the commands of the user, whereby the display unit displays the information independently of the contemporaneously detected objects.

3. The system as claimed in claim 1, wherein the command detection unit detects voice commands of the user.

4. The system as claimed in claim 1, further comprising feedback devices transmitting feedback to the user, wherein the control unit generates the feedback.

5. The system as claimed in claim 4, wherein the feedback comprises acoustic feedback.

6. The system as claimed in claim 1, wherein the objects are provided with at least one marker, enabling the control unit to recognize the objects detected by the image detection unit, and wherein the information displayed is associated with the at least one marker.

7. The system as claimed in claim 1, wherein the objects are provided respectively with at least one marker, causing the control unit to recognize the objects detected by the image detection unit, and wherein the respective items of information are associated with the respective markers.

8. The system as claimed in claim 1, wherein the display unit is a head-mounted display that superimposes the information on the field of vision of the user.

9. The system as claimed in claim 1, in an augmented reality environment, wherein the control of the linkage causes an object-independent display of the information on the display unit of a previously object-dependent display of the information on the display unit.

10. The system as claimed in claim 9, wherein commands of the user initiate and terminate the object-independent representation.

11. A method comprising:
displaying information,
detecting objects in a field of vision of a user,
detecting commands given by the user,
recognizing the detected objects,
processing the detected commands of the user, and
controlling a linkage between the displayed information and the detected objects in accordance with the commands given by the user.

12. The method as claimed in claim 11, further comprising:
reversibly interrupting the linkage between the display information and the detected objects in accordance with the commands of the user, wherein the information is displayed independently of the detected objects.

13. The method as claimed in claim 11, wherein the commands given by the user comprise voice commands.

14. The method as claimed in claim 11, further comprising:
generating feedback and transmitting the feedback to the user.

15. The method as claimed in claim 14, wherein the feedback comprises acoustic feedback.

16. The method as claimed in claim 11, further comprising:
providing the objects with at least one marker,
recognizing the detected objects, and
associating the information displayed with the at least one marker.

17. The method as claimed in claim 11, further comprising:
providing the objects each with at least one marker,
recognizing the detected objects, and
associating the respective items of information with the respective markers.

18. The method as claimed in claim 11, wherein the information is superimposed on the field of vision of the user via a head-mounted display.

19. The method as claimed in claim 11, in an augmented reality environment, wherein the controlling of the linkage comprises displaying an object-independent display of the information of a previously object-dependent display of the information.

20. The method as claimed in claim 19, wherein commands of the user initiate and terminate the object-independent representation.

21 Computer program product for programming a control unit in a system comprising:
a display unit displaying information,
an image detection unit detecting objects in a field of vision of a user,
a command detection unit detecting commands given by the user, and
a control unit controlling the display unit, recognizing the objects detected by the image detection unit, and processing the commands of the user detected by the command detection unit,
wherein the control unit further provides a linkage, controlled by the commands given by the user, between the displayed information and the contemporaneously detected objects.

22. A system comprising:
a display means for displaying information,
an image detection means for detecting objects in a field of vision of a user,
a command detection means for detecting commands given by the user, and
a control means for controlling the display unit, recognizing the objects detected by the image detection unit, and processing the commands of the user detected by the command detection unit,
wherein the control means further provides a linkage, controlled by the commands given by the user, between the displayed information and the contemporaneously detected objects.

23. A component of an augmented reality system, comprising:
an object recognition device configured to associate a plurality of predetermined objects with respective sets of information,
a visual display unit configured to display the respective sets information in accordance with associations by the object recognition device,
a processor configured to control the visual display unit to operate selectively in an object-dependent mode and an object-independent mode, and
a user interface configured to receive a signal for the processor indicative of a user's selection of one of the object-dependent mode and the object-independent mode.
